(19) United States
(12) Patent Application Publication
(10) Pub. No.: US 2005/0144793 A1
(43) Pub. Date: Jul. 7, 2005

(54) Protractable tool

(76) Inventors: James R. Nelson, Sioux Falls, SD (US); George O. Leih, Sioux Falls, SD (US)

Correspondence Address: Angenehm Law Firm Ltd., P.O. Box 48755, Coon Rapids, MN, 55448-0755, US

(21) Appl. No.: 11/074,166

(22) Filed: Mar. 7, 2005

Related U.S. Application Data
(63) Continuation-in-part of application No. 10/374,178, filed on Feb. 25, 2003.

(51) Int. Cl. B43L 13/02

(52) U.S. Cl. 33/42

(57) ABSTRACT

A tool, including a base having a base edge, the base edge being adapted to align in a substantially parallel orientation with an edge of a work piece; and a swing arm having a work edge formed thereon, the swing arm being pivotally mounted on the base at a point where the base edge and swing arm intersect.

### CROSS REFERENCE TO RELATED APPLICATION

This application is a continuation-in-part of application Ser. No. 10/374,178, filed Feb. 25, 2003.

### BACKGROUND OF THE INVENTION

1. Field of the Invention

The present invention relates to tool guides and more particularly pertains to a new adjustable protractable tool positioning guide for performing operations with tools on a work piece at an accurate distance and orientation with respect to edges or other features of the work piece in a highly convenient manner.

2. Description of the Prior Art

Devices have been proposed and produced that are designed to guide the movement of tools with respect to a work piece in a particular orientation to the geometry of the work piece. These guides are often used to guide the movement of a saw, such as a power saw, across a work piece to cut the work piece to a desired length.

While the use of such guides can be useful, especially when a large number of work pieces need to be cut to various lengths, the guides are most useful if a lateral side of the shoe of the power saw can be slid along a portion of the guide that is oriented substantially parallel to the desired direction of movement of the saw. However, the typical configuration of portable circular power saws is irregular in the sense that the housing often extends for a significant distance from one side of the saw beyond one lateral edge of the shoe, while the housing does not extend beyond the other lateral edge of the shoe. Typically, the protruding housing interferes with the movement of one of the lateral sides of the shoe along the known guides, especially those guides that employ conventional measuring tape devices that tend to extend upwardly from the surface of the work piece, and interfere with the movement of the protruding housing. As a result, only the lateral side over which the housing of the saw does not extend is able to slide along the guides. This can be problematic as this requires the user of the saw to either only use one hand to hold the saw (regardless of whether the user is right-handed or left-handed) or position himself or herself on only one side of the work piece (but not the other). This has significantly limited the usefulness of such guide devices.

Another difficulty that limits the known guide devices is the ability to accurately measure the distance between the end of the work piece and the operative edge of the guide, or more usefully, the saw blade of the saw as the saw is moved along the operative edge of the guide device. Since a tape measure used in conjunction with these devices cannot extend all the way to the saw blade without hampering movement of the saw, the distance measurement indicated on the tape is not the actual distance from the end of the work piece. Some type of adjustment needs to be made to the reading of the tape measure at some point, such as adding a known compensating distance to the distance indicated on the tape to compensate for the distance between the saw blade and the measurement indicated on the tape. This requires repeated calculations at each measurement, and introduces the possibility of measurement errors when numerous measurements are made, even when the adjustment to the measurement is deemed to be simple.

The known guide devices are also limited in their capability to guide tool movement at angles that are not parallel or perpendicular to the edges of the work piece.

In these respects, the adjustable protractable tool positioning guide according to the present invention substantially departs from the conventional concepts and designs of the prior art, and in so doing provides an apparatus primarily developed for the purpose of performing operations with tools on a work piece at an accurate distance and orientation with respect to edges or other features of the work piece in a highly convenient manner.

### SUMMARY OF THE INVENTION

In view of the foregoing disadvantages inherent in the known types of tool guides now present in the prior art, the present invention provides a new adjustable protractable tool positioning guide wherein the same can be utilized for performing operations with tools on a work piece at an accurate distance and orientation with respect to edges or other features of the work piece in a highly convenient manner.

To attain this, the present invention generally contemplates a adjustable protractable tool positioning guide that includes a base for positioning on the work piece, with the base having a base edge for aligning in a substantially parallel orientation with a longitudinal axis of the work piece. The guide also includes a swing arm having a work edge formed thereon. The swing arm is pivotally mounted on the base such that an angle orientation of the work edge with respect to the base, and the base edge, is adjustable. The swing arm is pivotable about a pivot point that is preferably collinear with the base edge and the work edge to provide a zero pivot radius. The swing arm has a retracted position in which the work edge is oriented substantially perpendicular to the base edge and an extended position in which the work edge is oriented substantially parallel to the base edge.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

A significant advantage of the present invention is that it provides a guide for the movement of a power saw or other tool with respect to a work piece in an orientation that is perpendicular to an edge of the work piece, or in an orientation that is not perpendicular or parallel but angled between these extremes so that cuts for work pieces such as stair stringers may be quickly and easily made in the material. This may be accomplished by either right or left handed users, regardless of which side of the work piece the user is working. Further, the tool guide of the present invention provides the user with an accurate, visually observable measurement of the distance between the end of the work piece and the blade of the power saw without requiring the user to adjust the measurement indicated by a tape measure. The tool guide of the present invention may also be easily adapted to work pieces with various widths. Additionally, auxiliary support may be provided to the tape of a tape measure used with the guide when large distances are to be measured.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic upper perspective view of a new adjustable protractable tool positioning guide according to the present invention.

FIG. 2 is a schematic end perspective view of the present invention.

FIG. 3 is a schematic side perspective view of the tape length adjustment structure of the present invention.

FIG. 4 is a schematic front view of the tape length adjustment structure of the present invention.

FIG. 5 is a schematic side view of the tool guide of the present invention in conjunction with a power saw.

FIG. 6 is a schematic top view of the present invention shown with the swing arm in the retracted position and the extension arm in the stored position.

FIG. 7 is a schematic partial top view of present invention shown with the swing arm substantially in the extended position.

FIG. 8 is a schematic top view of the present invention with an optional removable tread indicator arm mounted on the swing arm.

FIG. 9 is a schematic sectional view of the swing arm and the tread indicator arm taken along line 9-9 of FIG. 8.

FIG. 10 is a schematic sectional view of the swing arm and an optional laser light emitting assembly mounted on the swing arm.

### DESCRIPTION OF PREFERRED EMBODIMENTS

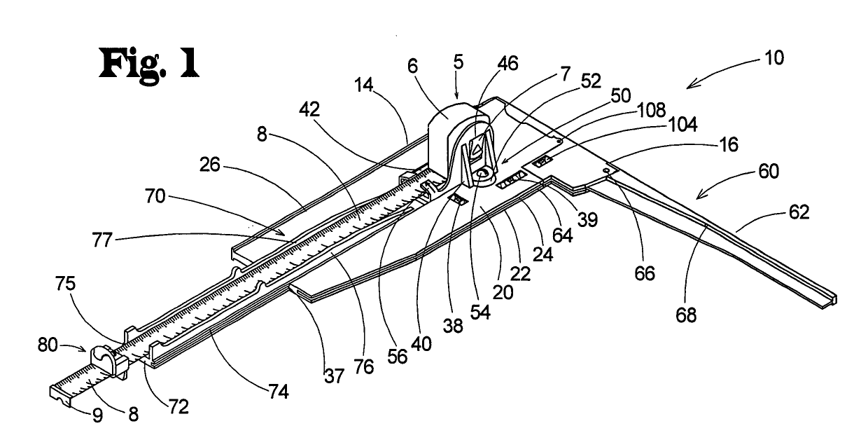

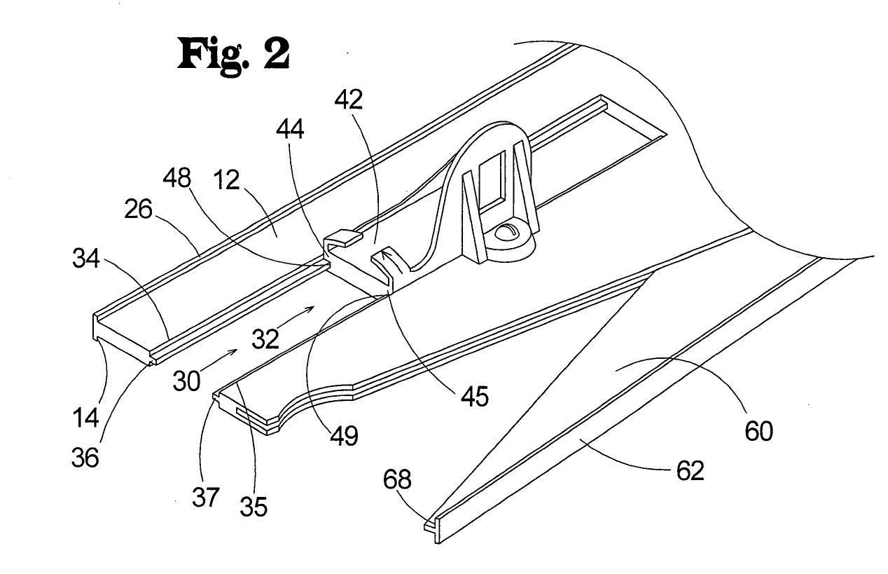

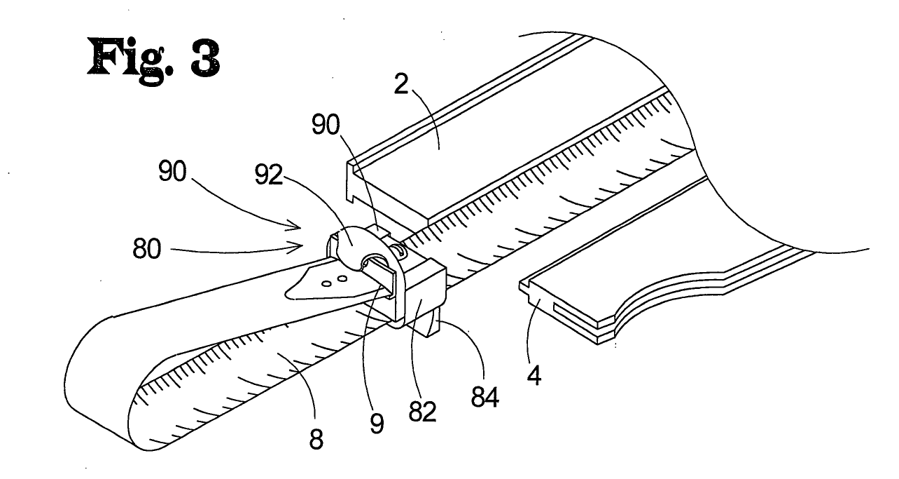

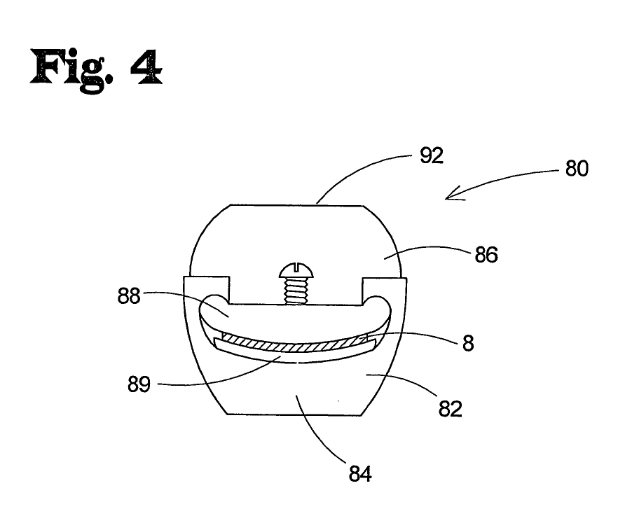

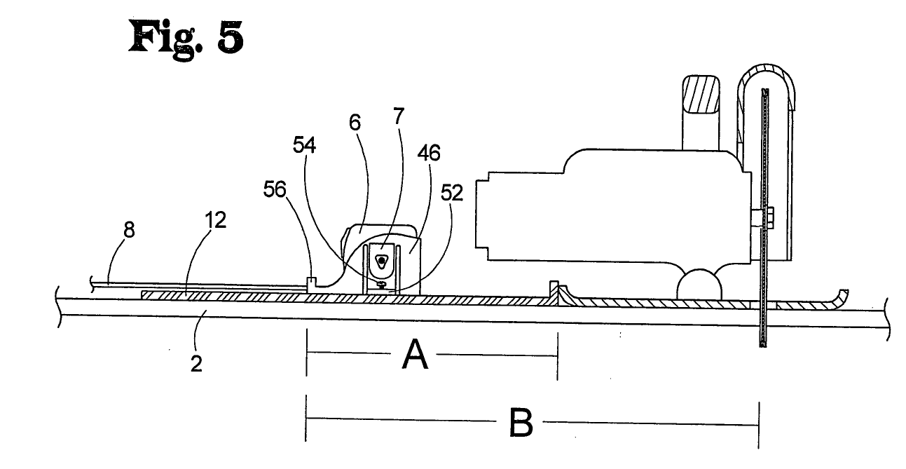

With reference now to the drawings, and in particular to FIGS. 1 through 10 thereof, a new adjustable protractable tool positioning guide embodying the principles and concepts of the present invention and generally designated by the reference numeral 10 will be described.

As best illustrated in FIGS. 1 through 10, the adjustable protractable tool positioning guide 10 may be used on a work piece 2 having an end 4 or edge (or other feature of the work piece) from which the user needs to measure and perform an operation. The tool guide 10 is suitable for positioning at an adjustable distance from the end 4 of the work piece 2 for facilitating operations on the work piece that require the establishment and maintenance of a stable edge at a selected distance on the work piece, such as, for example, marking the work piece with a marking tool or guiding the movement of a saw or other tool with respect to the work piece. The tool guide is suitable for use with an otherwise conventional tape measure 5 having a housing 6, a mounting clip 7, and a length of tape 8 extendable from and retractable back into the housing. The tape 8 has an end 9 which typically includes structure such as a tab for hooking or wedging on an end or edge of a work piece, and from which a plurality of measurement indicia are marked along the length of the tape.

The guide 10 includes a base 12 for positioning on the work piece 2. The base 12 has a base edge 14 that may be aligned in a substantially parallel orientation with the particular length of the work piece 2 being measured, such as along a longitudinal axis of the work piece 2, or along a longitudinal side edge of a board of dimension lumber. A swing arm 94, which is described in greater detail below, has a work edge 16 formed thereon. The swing arm 94 is pivotally mounted on the base 12 such that an angle orientation of the work edge 16 with respect to the base edge 14 is adjustable. Significantly, the line of the base edge 14 and the line of the work edge 16 intersect at a point about which the swing arm 94 pivots with respect to the base 12, so that pivoting the swing arm 94 does not vary the position of the point where the line of the base edge 14 and the line of the work edge 16 intersect.

The base 12 has a top side 20 and a bottom side 22, and may also have an auxiliary edge 24 that is located on the base 12 opposite the base edge 14. Various measurement indicia may be marked on the top side (and even the bottom side) of the base along the edges or on other locations on the side. Optionally, a first bubble tube 38 may be mounted on the base 12, with the first bubble tube 38 having a first longitudinal axis that extends in the direction of the length of the first bubble tube. This first longitudinal axis may be oriented substantially perpendicular to the base edge 14. As a further option, a second bubble tube 39 may be mounted on the base 12, with the second bubble tube 39 having a second longitudinal axis that extends in the direction of the length of the second bubble tube. Preferably, the second longitudinal axis is oriented substantially parallel to the first longitudinal axis, and may be oriented substantially parallel to the base edge 16.

The base 12 of the guide 10 may include an alignment shoulder 26 or flange that is restable against a longitudinal edge of the work piece (such as, for example, the longitudinal side edge of dimension lumber) to align the base edge 14 with the longitudinal axis or length of the work piece. The alignment shoulder may extend or protrude from the bottom side 22 of the base 12 such that when the bottom side is rested against the upper face of a work piece, the alignment shoulder may be pressed against or snugged up against an edge (such as a longitudinal edge) of the work piece. The alignment shoulder 26 may also extend from the top side 20 of the base 12 to permit the base to be oriented in an opposite direction for manipulation by the left- or right-hand of the user.

The base 12 may also have a guide structure 30 formed thereon for guiding movement of the tape measure mounting assembly discussed below. In one embodiment of the invention, the guide structure 30 may include a slot 32 that is formed in the base 12 and extends between the top side 20 and the bottom side 22 of the base. The slot 30 may be elongate and have a longitudinal axis that extends substantially parallel to the base edge 14. The slot 30 may extend into a generally central area of the base from one end edge of the base toward the other end edge of the base, and the slot may extend through one of the end edges. The slot 32 may be defined by a pair of opposite side edges 34, 35 that extend along opposite sides of the slot. The opposite side edges 34, 35 may be oriented substantially parallel to each other. The guide structure 30 may also include a pair of tongues 36, 37, with each tongue being formed on one of the opposite side edges 34, 35 of the slot 32. Each of the tongues 36, 37 extend into the slot and are oriented in substantial opposition to each other.

The tape measure mounting assembly 40 of the guide 10 mounts the tape measure 5 on the base 12. The tape measure mounting assembly 40 is slidably mounted on the base 12 along a line that is oriented substantially parallel to the base edge 14 of the base 12. The mounting assembly 40 may extend into the slot 32 of the base 12 and is movable in the slot. The mounting assembly 40 may be mounted on the tongues 36, 37 of the side edges 34, 35 of the slot 32. The tape measure mounting assembly 40 may include a mounting plate 42 that is selectively slidably mounted on the base 12. The mounting plate 42 has marginal side portions 44, 45 located on opposite side locations of the mounting plate, and the marginal side portions may each include a groove 48, 49 for slidably receiving the respective tongues 36, 37 of the opposite side edges 34, 35 of the slot 32. The tape measure mounting assembly 40 may also include a mounting ear 46 that extends from the mounting plate 42 for removably securing the tape measure 5 to the mounting plate, and includes a hole formed therein for passing a clip fastener therethrough. The mounting ear 46 is positionable between the housing 7 of the tape measure 5 and the securing clip 7 of the tape measure so that securing the securing clip 7 to the housing 6 mounts the tape measure 5 to the mounting ear 46 and the mounting plate 42.

The tape measure mounting assembly 40 may also include means for securing the position of the mounting plate 42 (and any tape measure 5 mounted thereon) in the slot 32 of the base, and thereby permits fixing of the distance between the work edge 16 and the tape measure 5. The securing means may comprise a position securing assembly 50 that includes a securing tab 52 that extends from the mounting plate 42 to a location over the base 12, and a securing fastener 54 that extends through the securing tab 52. The securing fastener 54 is threadedly mounted on the securing tab 52 so that rotation of the fastener advances an end of the fastener toward and against the base 12 to restrict or prevent movement of the mounting plate 42 with respect to the slot 32 in the base, and rotation of the fastener in an opposite direction moves the end of the fastener away from the base to permit relatively free movement of the mounting plate 42 with respect to the base 12.

Optionally, the mounting assembly 40 may include at least one indicator tab 56 that extends from the mounting plate 42 for positioning over an extended portion of the tape 8 of the tape measure 5 for visual alignment with the measurement indicia on the tape to facilitate reading of the measurement of the tape.

The guide 10 of the invention may also include an elongate tape support member 70 for supporting an extended portion of the tape 8 of the tape measure 5 when the tape is extended from the housing 6. The tape support member 70 may be removably mounted on the base 12, and in one embodiment of the invention the tape support member is removably insertable into the slot 32 of the base for positioning adjacent to the tape measure mounting assembly 40 in the slot. The tape support member 70 may include a bottom wall 72 for resting a portion of the tape 8 thereon. The bottom wall 72 may have opposite side edges 74, 75 that have grooves for receiving the tongues 36, 37 of the side edges 36, 37 of the slot 32. The tape support member 70 may also include a pair of side walls 76, 77 that are mounted on and extend upwardly from the bottom wall 72. In one embodiment of the invention, the side walls 76, 77 extend substantially parallel to each other to form a channel for receiving and resisting lateral movement of the tape 8.

The invention may also include a tape length adjustment structure 80 that is removably mountable on the tape 8 of the tape measure 5 as a means for adjusting an effective extension length of the tape from the housing 6 of the tape measure 5. The tape length adjustment structure 80 may be positionable at a selected distance from the end 9 of the tape 8, and the selected distance may suitably correspond to a distance B between the work edge 16 and the indicator tab 56, but may also be positioned to reflect the distance A between the indicator tab and the saw blade of a power saw when the shoe of the power saw is rested against the work edge. In this configuration, the measurement shown at the indicator tab 56 of the position securing assembly 50 reflects the actual distance between the end of the tape and the work edge or saw blade. Thus, the user may use the alignment of the indicator tab 56 with measurement indicia on the measuring tape to determine the distance between the end of the work piece and the saw blade of the saw when the saw is positioned against the work edge 16.

The tape length adjustment structure may include a first portion 82 which may form a substantially U-shaped channel 83 and may have a concave upper surface. The first portion 82 may include an auxiliary tape ledge 84 for hooking on an edge of the work piece in a manner similar to the ledge or tab at the end of a measuring tape. The auxiliary tape ledge 84 may extend from the first portion 82 in a direction that is substantially opposite of the channel 83. The tape length adjustment structure 80 may also include a second portion 86 that is removably mounted on the first portion 82. A part of the second portion 86 may be removably nestable in the channel 83 of the first portion 82. The second portion 86 may comprise first 88 and second 89 sections that are pivotally mounted together for selectively pinching a portion of the tape 8 of the tape measure therebetween. The first 88 and second 89 sections of the second portion 86 may be held together when the part of the second portion is nested or positioned in the channel 83 of the first portion 82 to pinch the tape 8.

Optionally, the tape length adjustment structure 80 may include means for minimizing the protrusion of the tape beyond the tape length adjustment structure so that this unutilized portion of the tape is less likely to, for example, unintentionally become hooked on things or interfere with the use of the tape. An attachment structure 90 may be provided as a means for attaching the end 9 of the tape 8 to an intermediate location on the tape where the tape length adjustment structure is positioned. The attachment structure may be mounted on the first portion 82 of the adjustment structure 80, and may comprise a hook 92 that is formed on the first portion for engaging the ledge or tab on the end 9 of the tape 8. The hook 92 may open toward the tape 8 extending through the adjustment structure, so that the extent of the tape adjacent to the end 9 of the tape may be folded over on itself and the ledge of the tape may be generally mounted on the hook 92 to form a loop.

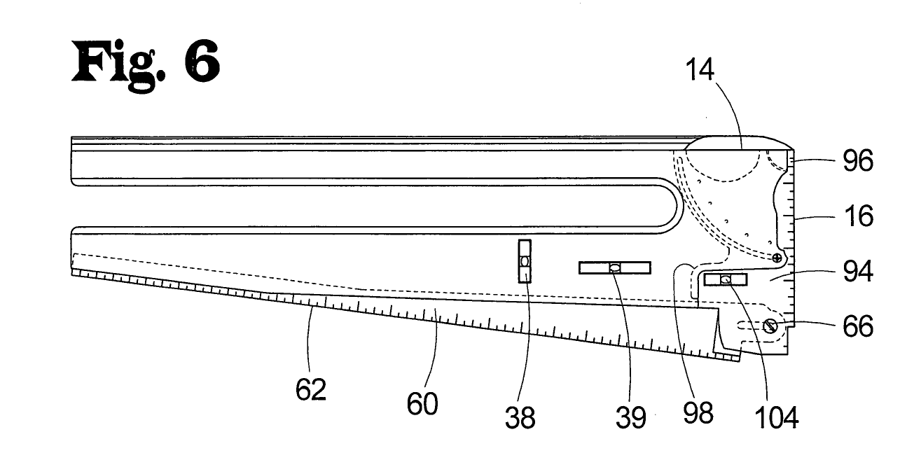

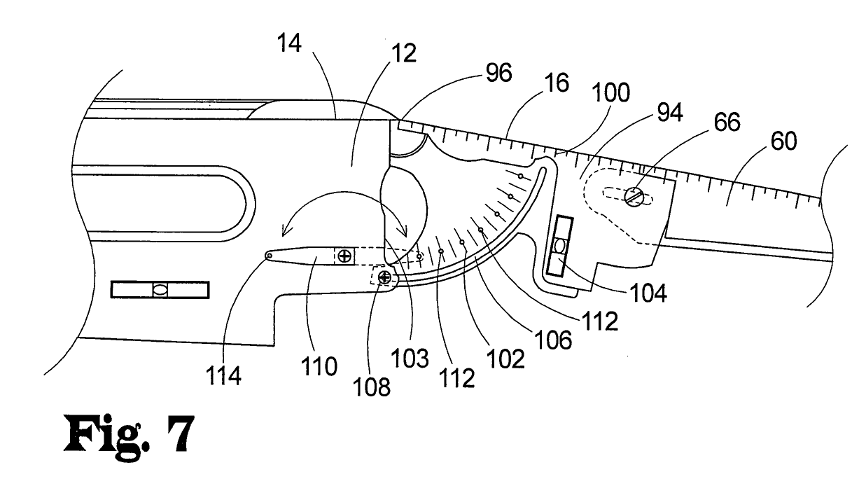

The swing arm 94 of the invention includes the work edge 16 and is pivotable about a pivot point 96 to permit adjustment of the angle orientation of the work edge 16 with respect to the base edge 14. The swing arm 94 may have a retracted position in which the work edge 16 is oriented substantially perpendicular to the base edge 14 (see FIG. 6) and may have an extended position in which the work edge 16 is oriented substantially parallel to the base edge 14 (see FIG. 7). The swing arm 94 is thus pivotally adjustable to a plurality of positions between the retracted and extended positions, with the work edge 16 assuming a plurality of angular orientations relative to the base edge.

In one embodiment of the invention, a portion of the swing arm 94 is nestable or insertable in a recess 98 formed in the base 12 (such as along an edge) when the swing arm 94 is moved from the extended position toward the retracted position. The nested portion of the swing arm 94 is thus substantially hidden from view when the swing arm is in the retracted position.

A plurality of measurement indicia 100 may be marked on the swing arm 94 along the work edge 16 for indicating a distance of the various hash marks along the work edge from (or relative to) the pivot point 96. Preferably, the pivot point 96 lies at the intersection of the base edge 14 and the work edge 16, so the measurement indicia 100 indicates the distance along the work edge from the base edge. A plurality of angular indicia 102 may also be marked on the swing arm 94 to indicate the measure of the angle between the work edge 16 and the base edge 14. An indicator edge 103 may be formed on the base 12 so as to be alignable with various indicia of the plurality of angular indicia 102 on the swing arm 94 to indicate the relative angular orientation of the work edge 16 with respect to the base edge 14 when the swing arm 94 is moved out of the retracted position toward the extended position.

Optionally, a third bubble tube 104 may be mounted on the swing arm 94. The third bubble tube 104 may have a third longitudinal axis that extends in the direction of the length of the tube 104 and that may be oriented substantially parallel to the second longitudinal axis of the second bubble tube 39 when the swing arm 94 is in the retracted position. The third bubble tube 104 is thus movable with the swing arm 94 as the swing arm is pivoted, and the third longitudinal axis of the third bubble tube may remain oriented substantially parallel to the work edge 16 as the swing arm 94 is pivoted.

In one embodiment of the invention, a guide slot 106 is formed in the swing arm 94. A pin 108 may be mounted on the base 12 and may extend across the recess 98 in the base 12. The pin 108 may be received in the guide slot 106, and the guide slot may be substantially arcuate to accommodate the movement of the pin 108 relative to the swing arm 94 when the swing arm is moved between the retracted and extended positions. Optionally, the pin 108 (or other fastener) may be selectively tightened to lock the relative position of the swing arm 94 with respect to the base 12 or loosened to release the swing arm for adjustment of its position relative to the base.

Optionally, the guide 10 may also include a locating assembly for selectively locating or securing the work edge 16 of the swing arm 94 in a selected pivot position with respect to the base edge 14 of the base 12. The locating assembly may include a locating arm 110 (see FIG. 7) that is pivotally mounted on the base 12 for selectively extending over the swing arm 94. The locating assembly may also include a plurality of depressions 112 formed on a face of the swing arm 94, and a peg 114 or other protrusion that is mounted on the locating arm 110 and that is selectively positionable in one of the depressions 112 on the swing arm 94 such that an interlock between the peg 114 and one of the depressions 112 resists movement of the swing arm 94 out of the position corresponding to that angular orientation of the work edge.

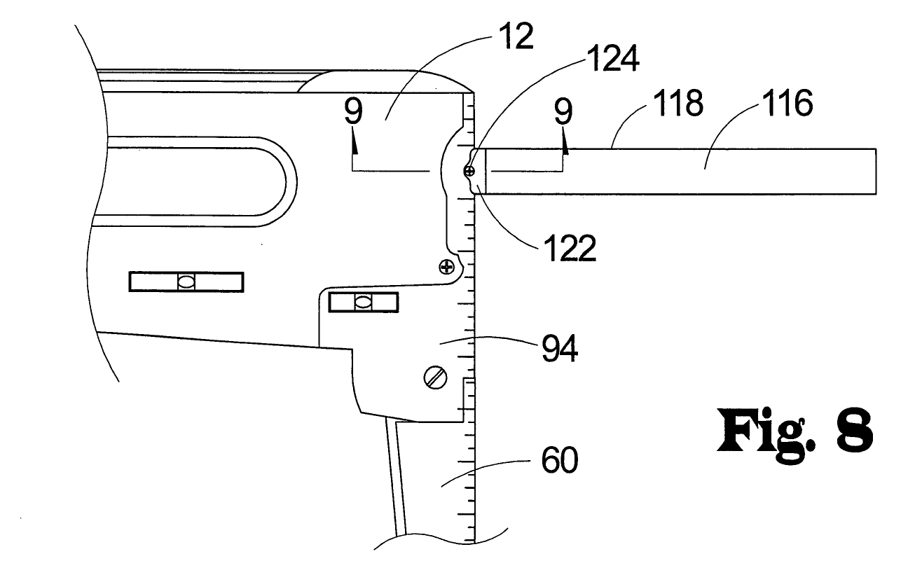

The guide 10 may also include an extension arm 60 that is mounted on the swing arm 94 for selectively extending the work edge 16 of the swing arm with a work extension edge 62 formed on the extension arm 60. The extension arm 60 may be pivotally mounted on the swing arm 94 such that the extension arm 60 has a use position (see FIG. 8) in which the work extension edge 62 is oriented substantially linear with the work edge 16 of the swing arm and a stored position (see FIG. 6) in which the extension arm 60 is positioned adjacent to the auxiliary edge 24 of the base 12.

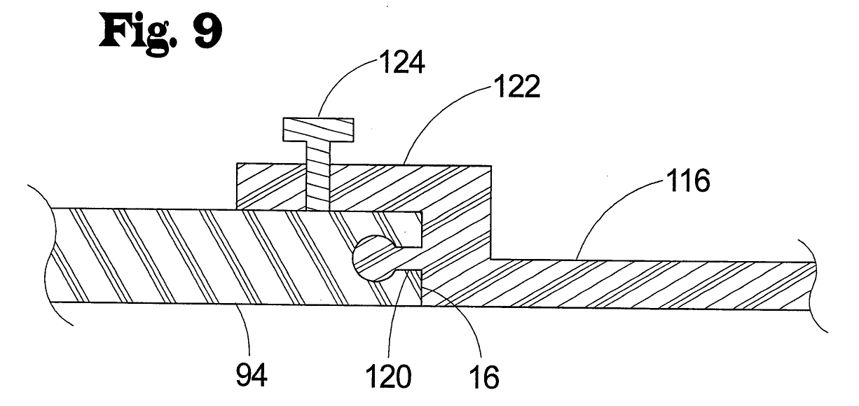

The guide 10 may further include a tread marking guide assembly (see FIGS. 8 and 9) for guiding the marking of a position or line of a tread on a work piece. The tread marking guide assembly may include a tread indicator arm 116 that is removably mounted on the swing arm 94, and may be movable (and thus positionable) along the work edge 16 of the swing arm 94. The tread indicator arm 116 may form a tread edge 118 for guiding the movement of a marking instrument, or a cutting tool, on the work piece. The tread edge 118 may be oriented substantially perpendicular to the work edge 16 when the tread indicator arm 116 is joined to the swing arm 94. The tread marking guide assembly may also include a channel 120 formed in the swing arm 94 for receiving a portion of the tread indicator arm 116 when the tread indicator arm is mounted on the swing arm 94. The channel 120 may extend along the work edge 16 such that the tread indicator arm 116 is slidably positionable along the work edge 16. The tread marking guide assembly may also include a securing tab 122 that is formed on the tread indicator arm 116 and that extends over a portion of the swing arm 94 when the tread indicator arm 116 is mounted on the channel 120. A securing fastener 124 may extend through the securing tab 122 for selectively bearing against the swing arm 94 to fix the position of the tread indicator arm 116 relative to the swing arm. It should be understood that the tread indicator arm 116 may be mounted on the swing arm 94 in any number of optional ways, such as, for example, using a magnet and a metal strip on the respective parts to achieve the desired removable and positionable mounting of the arm 116 to the swing arm 94.

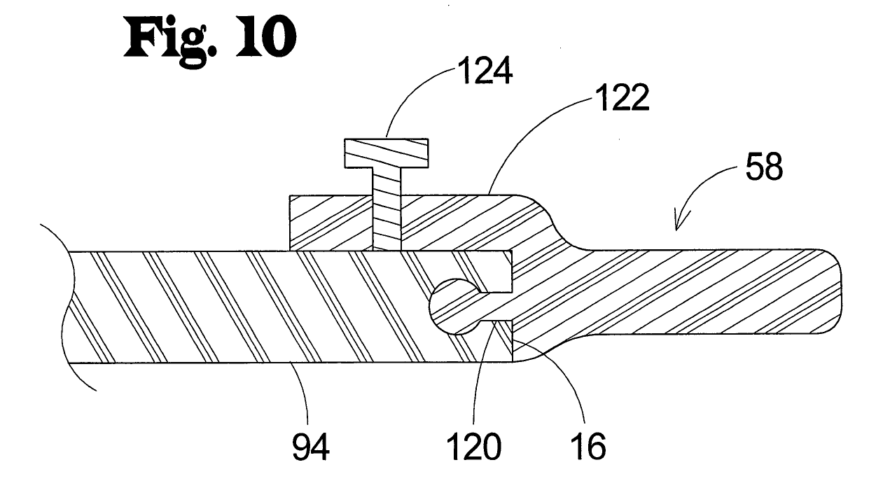

As a further option, the guide may also include a laser light emitting assembly 58 (see FIG. 10) for emitting laser light from the guide. The laser light emitting assembly 58 may be removably mounted on and movable along the work edge 16 of the swing arm 94 and the work extension edge 62 of the extension arm 60. Mounting structure similar to the structure employed to mount the tread indicator arm on the swing arm 94 may be employed, such as is illustrated in FIG. 10, although other mounting structures and mounting positions for the laser light emitting assembly may be employed. Illustratively, the laser light emitting assembly 58 may be mounted on structure similar to the tape measure mounting assembly 40 described above, so that the laser light emitting assembly is movable along the slot 32 of the base and may be removable from the base when the tape measure mounting assembly is employed on the guide. Optionally, the laser light emitting assembly 58 may be permanently or semi-permanently mounted on the base 12 alongside the slot 32, or may be removable for separate storage or transport, for example, a carrying pouch.

In use, the tape measure 5 is mounted on the tape measure mounting assembly 40 by positioning the mounting ear 46 of the mounting assembly between the housing 6 and the clip 7 of the tape measure 5, which may require temporary removal of the clip from the housing by unscrewing a threaded fastener, and passing the fastener through the clip, the hole in the mounting ear, and into the housing 6 of the tape measure. The mounting plate 42 of the mounting assembly may then be positioned in the slot 32 with the grooves 48, 49 of the mounting plate receiving each of the tongues 36, 37 of the side edges defining the slot.

The position of the mounting plate 42 and measuring tape may then be adjusted in the slot 32 at a suitable distance from the work edge 16. A suitable distance may be determined by, for example, the degree to which the motor housing of a power saw to be used with the guide 10 overhangs the base 12 when the power saw is moved along the work edge 16 during cutting movement. Since the upward protrusion of the housing 6 of the tape measure may interfere with the movement of the motor housing while the saw is moved along the work edge, the mounting plate 42 and the tape measure may need to be moved further away from the work edge then might otherwise be necessary in order to provide sufficient clearance for the movement of the motor housing of the saw.

Once a suitable distance is determined, the securing fastener 54 of the position securing assembly may be tightened to secure the mounting plate 42 against movement in the slot 32 with respect to the base 12. The distance between the work edge and the indicator tab 56 on the mounting assembly is determined, and the tape adjustment structure 80 is positioned on the tape 8 at a similar if not identical distance from the end 9 of the tape, so that the auxiliary tape ledge 84 is located at that distance from the end of the tape. The effective length of the extended portion of the tape that is read at the indicator tab 56 is thus corrected for the distance between the indicator tab and the work edge.

The auxiliary tape ledge 56 may then be hooked or otherwise secured to an end of the work piece from which the operation, such as cutting, is to be performed. The guide 10 is moved down the length of the work piece until the portion of the tape 8 positioned adjacent to the indicator tab 56 aligns with the indicia on the tape at the desired measurement from the end of the work piece. The base edge 14 of the base 12 may then be aligned with a side edge of the work piece, such as by pressing the alignment shoulder 26 against the side edge. The work edge 16 is thus positioned at the desired distance from the end of the work piece and the work edge is also oriented perpendicular to the side edge of the work piece.

If the width of the work piece is relatively great, the extension arm 60 may be pivoted from the stored position to the use position so that the work extension edge 62 extends the work edge 16 for guidance over a greater distance. If the length of the work piece is relatively great, the tape support member 70 may be mounted on the slot 32 of the base 12 to support the portion of the tape located near the housing 6 of the tape measure.

If the cut to be made in the work piece is to be oriented at a non-perpendicular angle to the base edge 14 (and thus non-parallel to the longitudinal edge of the work piece), the swing arm 94 may be pivoted relative to the base 12 until the work edge 16 reaches the desired angular orientation with respect to the base edge 14, which may be indicated by the indicator edge 103 being aligned with the angular indicia 102 on the swing arm 94 that corresponds to the desired angular orientation. Optionally, the locator arm 110 may be pivoted out over the swing arm 94 so that the peg 114 of the locating arm 110 is able to engage an appropriate one of the depressions on the swing arm 94 to hold the swing arm in the desired position. The tool may then be moved along the work edge 16 such that the movement occurs at a desired angle with respect to the edge of the work piece.

With respect to the above description then, it is to be realized that the optimum dimensional relationships for the parts of the invention, to include variations in size, materials, shape, form, function and manner of operation, assembly and use, are deemed readily apparent and obvious to one skilled in the art in light of the foregoing description, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A tool, comprising:
a base having a base edge, the base edge being adapted to align in a substantially parallel orientation with an edge of a work piece; and
a swing arm having a work edge formed thereon, the swing arm being pivotally mounted on the base at a point where the base edge and swing arm intersect.

2. The tool of claim 1 wherein a portion of the swing arm is insertable in a recess formed in the base when the swing arm is moved from an extended position to a retracted position.

3. The tool of claim 1 wherein a plurality of angular indicia indicate angular orientation of the work edge with respect to the base edge.

4. The tool of claim 1 wherein a first bubble tube is mounted on the base with a first longitudinal axis, a second bubble tube is mounted on the base with a second longitudinal axis, and the first and second longitudinal axis being generally perpendicular.

5. The tool of claim 4 wherein a third bubble tube is mounted on the swing arm.

6. The tool of claim 1 additionally comprising an extension arm having a work extension edge, the work extension arm being pivotally mounted on the swing arm, the extension arm having a use position in which the work extension edge is oriented substantially linear with the work edge of the swing arm.

7. The tool of claim 1 additionally comprising a locating assembly for selectively locating the work edge of the swing arm in a selected pivot position with respect to the base edge of the base.

8. The tool of claim 7 wherein the locating assembly comprises a locating arm pivotally mounted on the base for selectively extending over the swing arm, a plurality of depressions formed on the swing arm, and a peg mounted on the locating arm and being selectively positioned in one of the depressions on the swing arm.

9. The tool of claim 1 additionally comprising a tread marking guide assembly, the tread marking guide assembly including a tread indicator arm mounted on the swing arm, the tread indicator arm having a tread edge, the tread edge being oriented substantially perpendicular to the work edge.

10. The tool of claim 9 wherein the tread marking assembly is slidably positionable along the work edge.

11. The tool of claim 1 additionally comprising a laser light emitting assembly mounted on the swing arm.

12. The tool of claim 1 additionally comprising a tape measure mounting assembly mounted on the base, the tape measure mounting assembly joining a tape measure to the base.

13. The tool of claim 12 additionally comprising a tool tape length adjustment means removably mountable on a tape of the tape measure.

14. The tool of claim 13 wherein the tape length adjustment means includes attachment means, the attachment means attaching an end of the tape to an intermediate location on the tape.

15. The tool of claim 1 wherein the base has an alignment shoulder.

16. The tool of claim 1 wherein the base has a guide structure formed therein, the guide structure including a slot formed in the base with a longitudinal axis extending substantially parallel to the base edge.

17. The tool of claim 16 wherein a tape measure mounting assembly extends into the slot of the base.

18. The tool of claim 17 wherein the tape measure mounting assembly comprises:
a mounting plate slidably mounted on the base; and
a mounting ear extending from the mounting plate securing the tape measure to the mounting plate.

19. The tool of claim 1 additionally comprising an elongate tape support member, the tape support member being mounted on the base.
